(19) United States
(12) Patent Application Publication
(10) Pub. No.: US 2022/0042146 A1
(43) Pub. Date: Feb. 10, 2022

(54) STRUCTURAL STEEL HAVING EXCELLENT BRITTLE FRACTURE RESISTANCE AND METHOD FOR MANUFACTURING SAME

(71) Applicant: POSCO, Pohang-si, Gyeongsangbuk-do (KR)

(72) Inventors: Il-Cheol YI, Gwangyang-si, Jeollanam-do (KR); Jae-Young CHO, Gwangyang-si, Jeollanam-do (KR); Sang-Deok KANG, Gwangyang-si, Jeollanam-do (KR)

(21) Appl. No.: 17/415,398

(22) PCT Filed: Dec. 13, 2019
(86) PCT No.: PCT/KR2019/017728

§ 371 Date: Jun. 17, 2021

(30) Foreign Application Priority Data
Dec. 19, 2018 (KR) 10-2018-0165147

(51) Int. Cl. C22C 38/04; B21B 37/74; C21D 8/02; C22C 38/00; C22C 38/02; C22C 38/06

(52) U.S. Cl. CPC C22C 38/04; B21B 37/74; C21D 8/0247; C22C 38/001; C22C 38/002; C21D 2211/001; C22C 38/06; C21D 2211/002; C21D 2211/005; C21D 2211/008; C22C 38/02

(57) ABSTRACT

A structural steel having excellent brittle fracture resistance according to an aspect of the present invention comprises, by weight %, 0.02-0.12% of C, 0.01-0.8% of Si, 1.5-2.5% of Mn, 0.005-0.5% of Al, 0.02% or less of P, 0.01% or less of S, 0.0015-0.015% of N, and the remainder of Fe and unavoidable impurities, wherein an outer surface layer portion and an inner central portion are microstructurally divided along the thickness direction, the surface layer portion comprises tempered bainite as a matrix structure, the central portion comprises bainitic ferrite as a matrix structure, and the NDT temperature by the NRL drop-weight test may be −70° C. or lower.

### TECHNICAL FIELD

The present disclosure relates to a structural steel and a method for manufacturing the same, and more particularly, to a structural steel and a method for manufacturing the same, which effectively improves brittle fracture resistance by optimizing a steel composition, a microstructure and a manufacturing process.

### BACKGROUND ART

In line with the recent trend of increasing the size of building structures, steel pipes for transportation, bridges, etc., demand for the development of structural steels having high strength characteristics has increased. In the past, steels were produced by applying a heat treatment method such as quenching-tempering to satisfy such high-strength characteristics, but recently, in terms of reducing production costs and securing weldability, steel produced by cooling after rolling has replaced the existing heat-treated steel. In the case of steel produced by cooling after rolling, impact toughness is improved due to a fine microstructure, but a microstructure having high strength such as bainite or martensite may be formed in a thickness direction from a surface layer portion of the steel due to excessive cooling and brittle fractures may easily occur by a hard phase thereof.

The Naval Research Lab. (NRL) drop weight test is a typical method for measuring resistance to brittle fracture. The NRL drop weight test is a testing method developed in 1953 by NRL, the US Naval Research Institute, to examine brittle fracture arrestability, which has been standardized in ASTME208. In this test, a short brittle bead for occurrence of cracks is formed in a central portion of a surface of a steel sheet having a size of 52×140 mm or 90×360 mm, and a test piece obtained by machining a notch at a central portion of the brittle bead, and testing is performed thereon. The test piece is cooled at several temperatures, and thereafter, both ends of the test piece are supported with the brittle bead facing downward, and a heavy weight is dropped from the opposite side to cause cracks from a front end of a notch. A nil ductility transition temperature (NDT), which is the highest temperature at which cracks propagate in a thickness direction of the test piece and the test piece is fractured, is obtained and compared with a limit temperature at which brittle fracture occurs, so as to be evaluated. That is, a steel having a lower NDT temperature may be evaluated to have excellent brittle fracture resistance.

Recently, in order to secure stability of large structures, the trend requires steels provided as materials of large structures to have excellent brittle fracture resistance, and steels having an NDT temperature satisfying a level of −70° C. or lower are evaluated to have brittle fracture resistance particularly suitable for large structures.

Therefore, it is urgent to develop a steel manufactured by cooling after rolling and having excellent NDT temperature characteristics to have excellent brittle fracture resistance, while effectively securing economical efficiency and weldability.

Patent document 1 proposes a technology for granularizing a surface layer portion of a steel, but the surface layer portion is mainly formed of equiaxed ferrite grains and elongated ferrite grains, and thus, the technology cannot be applied to high-strength steels having a tensile strength of 800 MPa or higher. In addition, in Patent document 1, in order to grain-refine the surface layer portion, a rolling process has to be essentially performed in the middle of recuperating heat in the surface layer portion, which makes it difficult to control the rolling process.

(Related Art Document)

(Patent document 1) Japanese Laid-Open Publication No. 2002-020835 (published on Jan. 23, 2002)

### DISCLOSURE

### Technical Problem

An aspect of the present disclosure may provide a structural steel having excellent brittle fracture resistance and a method for manufacturing the same. The technical problem of the present disclosure is not limited to the above description. Those skilled in the art will have no difficulty in understanding an additional technical problem of the present disclosure from the general contents of the present disclosure.

### Technical Solution

According to an aspect of the present disclosure, a structural steel having excellent brittle fracture resistance includes, by wt %, 0.02% to 0.12% of carbon (C), 0.01% to 0.8% of silicon (Si), 1.5% to 2.5% of manganese (Mn), 0.005% to 0.5% of aluminum (Al), 0.02% or less of phosphorus (P), 0.01% or less of sulfur (S), 0.0015% to 0.015% of nitrogen (N), and the balance of Fe and other inevitable impurities, wherein an outer surface layer portion and an inner central portion may be microstructurally distinguished from each other in a thickness direction, the surface layer portion may include a tempered bainite as a matrix structure, the central portion may include bainitic ferrite as a matrix structure, and a nil ductility transition (NDT) temperature based on naval research lab. (NRL) drop weight test may be −70° C. or lower.

The surface layer portion may include an upper surface layer portion in an upper portion of the steel and a lower surface layer portion in a lower portion of the steel, and the upper surface layer portion and the lower surface layer portion may each have a thickness of 3% to 10% of a thickness of the steel.

The surface layer portion may further include fresh martensite as a second structure, and the tempered bainite and the fresh martensite may be included in the surface layer portion in a fraction of 95 area % or more.

The surface layer portion may further include austenite as a residual structure, and the austenite may be included in the surface layer portion in a fraction of 5 area % or less.

The bainitic ferrite may be included in the central portion in a fraction of 95 area % or more.

An average grain size of the surface layer portion may be 3 μm or less (excluding 0 μm).

An average grains size of the central portion may be 5 μm to 20 μm.

The steel may further include, by wt %, one or more selected from among 0.01% to 2.0% of nickel (Ni), 0.01% to 1.0% of copper (Cu), 0.01% to 1.0% of chromium (Cr), 0.01% to 1.0% of molybdenum (Mo), 0.005% to 0.1% of titanium (Ti), 0.005% to 0.1% of niobium (Nb), 0.005% to 0.3% of vanadium (V), 0.0005% to 0.004% of boron (B), and 0.006% or less of calcium (Ca).

A high angle grain boundary fraction of the surface layer portion may be 45% or more.

According to another aspect of the present disclosure, a method for manufacturing a structural steel having excellent brittle fracture resistance includes re-heating a slab including, by wt %, 0.02% to 0.12% of carbon (C), 0.01% to 0.8% of silicon (Si), 1.5% to 2.5% of manganese (Mn), 0.005% to 0.5% of aluminum (Al), 0.02% or less of phosphorus (P), 0.01% or less of sulfur (S), 0.0015% to 0.015% of nitrogen (N), and the balance of Fe and other inevitable impurities in a temperature range of 1050° C. to 1250° C.; rough-rolling the slab in a temperature range of Tnr to 1150° C. to provide a rough-rolled bar; first cooling the rough-rolled bar at a cooling rate of 5° C./s or higher to a temperature range of Ms to Bs° C.; maintaining the first cooled rough-rolled bar such that a surface layer portion thereof is reheated to a temperature range of (Ac1+40° C.)˜(Ac3-5° C.) by heat recuperation; finish rolling the recuperated rough-rolled bar; and secondary cooling the finish rolled steel to a temperature range of 200° C. to 500° C. at a cooling rate of 5° C./s or higher.

The slab may further include one or two or more selected from the group consisting of, by wt %, 0.01% to 2.0% of nickel (Ni), 0.01% to 1.0% of copper (Cu), 0.01% to 1.0% of chromium (Cr), 0.01% to 1.0% of molybdenum (Mo), 0.005% to 0.1% of titanium (Ti), 0.005% to 0.1% of niobium (Nb), 0.005% to 0.3% of vanadium (V), 0.0005% to 0.004% of boron (B), and 0.006% or less of calcium (Ca).

The rough-rolled bar may be first cooled by water cooling immediately after the rough rolling.

The first cooling may be initiated at a temperature of Ae3+100° C. or lower based on a temperature of a surface layer portion of the rough-rolled bar.

The rough-rolled bar may be finish-rolled in a temperature range of Bs to Tnr° C.

All of the features of the present disclosure are not listed as means for solving the above problems, and various features of the present disclosure and advantages and effects thereof will be understood in more detail with reference to the specific embodiments below.

### Advantageous Effects

According to an aspect of the present disclosure, a structural steel having excellent brittle fracture resistance, having an NDT temperature of −70° C. or lower by an NRL drop weight test, while having high strength characteristics, and a method for manufacturing the same may be provided.

### DESCRIPTION OF DRAWINGS

FIG. 1 is a photograph of a cross section of a steel specimen according to an embodiment of the present disclosure.

FIG. 2 is a photograph of observing a microstructure of an upper surface layer portion A and a central portion B of the specimen of FIG. 1.

FIG. 3 is a diagram schematically illustrating an example of equipment for implementing a manufacturing method of the present disclosure.

FIG. 4 is a conceptual diagram schematically illustrating a change in a microstructure of a surface layer portion by a heat recuperation treatment of the present disclosure.

FIG. 5 is a graph illustrating an experimentally measured relationship between a heat recuperation arrival temperature and an NDT temperature.

### BEST MODE FOR INVENTION

The present disclosure relates to a structural steel having excellent brittle fracture resistance and a method for manufacturing the same, and hereinafter, embodiments of the present disclosure will be described. The embodiments of the present disclosure may be modified in various forms, and the scope of the present disclosure should not be construed as being limited to the embodiments described below. The present embodiments are provided to those skilled in the art to which the present disclosure pertains to further specify the present disclosure.

Hereinafter, a steel composition of the present disclosure will be described in more detail. Hereinafter, unless otherwise indicated, % and ppm representing the content of each element are based on weight.

A structural steel having excellent brittle fracture resistance according to an aspect of the present disclosure may include, by wt %, 0.02% to 0.12% of carbon (C), 0.01% to 0.8% of silicon (Si), 1.5% to 2.5% of manganese (Mn), 0.005% to 0.5% of aluminum (Al), 0.02% or less of phosphorus (P), 0.01% or less of sulfur (S), 0.0015% to 0.015% of nitrogen (N), and the balance of Fe and other inevitable impurities. In addition, the structural steel having excellent brittle fracture resistance according to an aspect of the present disclosure may further include, by wt %, 0.01% to 2.0% of nickel (Ni), 0.01% to 1.0% of copper (Cu), 0.01% to 1.0% of chromium (Cr), 0.01% to 1.0% of molybdenum, 0.005% to 0.1% of titanium (Ti), 0.005% to 0.1% of niobium (Nb),0.005% to 0.3% of vanadium (V), 0.0005% to 0.004% of boron (B), and 0.006% or less of calcium (Ca).

Carbon (C): 0.02% to 0.12%

Carbon (C) is an important element to ensure hardenability in the present disclosure. In addition, carbon (C) is also an element significantly affecting formation of a bainitic ferrite structure in the present disclosure. Accordingly, carbon (C) needs to be included in the steel within an appropriate range in order to achieve such an effect, and in the present disclosure, a lower limit of a carbon (C) content may be limited to 0.02%. The carbon (C) content may preferably be 0.03% or more and more preferably 0.04% or more. However, if the carbon (C) content exceeds a certain range, low-temperature toughness of the steel may decrease, and thus, in the present disclosure, an upper limit of the carbon content may be limited to 0.12%. Accordingly, the carbon (C) content of the present disclosure may be 0.02% to 0.12%. The carbon (C) content may preferably be 0.11% or less and more preferably 0.10% or less. In addition, in the case of a steel provided for a welding structure, it is more preferable to limit the range of the carbon (C) content to 0.03% to 0.08% in terms of securing weldability.

Silicon (Si): 0.01% to 0.8%

Silicon (Si) is an element used as a deoxidizer and is an element contributing to improving strength toughness. Accordingly, in order to obtain this effect, in the present disclosure, a lower limit of a silicon (Si) content may be limited to 0.01%. The silicon (Si) content may preferably be 0.05% or more and more preferably 0.1% or more. However, an excessive addition of silicon (Si) may deteriorate low-temperature toughness and weldability, and thus, in the present disclosure, an upper limit of the silicon content may be limited to 0.8%. The silicon (Si) content may preferably be 0.7% or less and more preferably 0.6% or less.

Manganese (Mn): 1.5% to 2.5%

Manganese (Mn) is an element useful for improving strength by solid solution strengthening and is also an element economically increasing hardenability. Accordingly, in order to obtain such an effect, in the present disclosure, a lower limit of a manganese (Mn) content may be limited to 1.5%. A manganese (Mn) content may preferably be 1.6% or more and more preferably 1.7% or more. However, an excessive addition of manganese (Mn) may significantly deteriorate toughness of a welded portion due to an excessive increase in hardenability, and thus, in the present disclosure, an upper limit of the manganese (Mn) content may be limited to 2.5%. The manganese (Mn) content may preferably be 2.45% or less and more preferably 2.4% or less.

Aluminum (Al): 0.005% to 0.5%

Aluminum (Al) is a typical deoxidizing agent economically deoxidizing molten steel and is also an element contributing to improving strength of steel. Thus, in order to achieve such an effect, in the present disclosure, a lower limit of an aluminum (Al) content may be limited to 0.005%. The aluminum (Al) content may preferably be 0.008% or more and more preferably 0.01% or more. However, an excessive addition of aluminum (Al) may cause clogging of a nozzle during continuous casting, and thus, in the present disclosure, an upper limit of the aluminum (Al) content may be limited to 0.5%. The aluminum (Al) content may preferably be 0.4% or less and more preferably 0.3% or less.

Phosphorus (P): 0.02% or less

Phosphorus (P) is an element contributing to improving strength and corrosion resistance, but it is preferable to maintain its content as low as possible because phosphorus (P) may significantly impair impact toughness. Therefore, a phosphorus (P) content of the present disclosure may be 0.02% or less.

Sulfur (S): 0.01% or less

Sulfur (S) is an element forming a non-metallic inclusion such as MnS to significantly inhibit impact toughness, so it is preferable to maintain its content as low as possible. Therefore, in the present disclosure, an upper limit of a sulfur (S) content may be limited to 0.01%. However, sulfur (S) is an impurity unavoidably introduced during a steelmaking process and it is not desirable to control sulfur (S) to a level lower than 0.001% in economic terms, and thus, the sulfur (S) content of the present disclosure may preferably be 0.001 to 0.01%.

Nitrogen (N): 0.0015% to 0.015%

Nitrogen (N) is an element contributing to improving of strength of a steel. However, an excessive addition thereof may significantly deteriorate toughness of the steel, and thus, in the present disclosure, an upper limit of a nitrogen (N) content is limited to 0.015%. However, nitrogen (N) is an impurity unavoidably introduced during a steelmaking process and it is not desirable to control the nitrogen (N) content to a level less than 0.0015% in economic terms, and the nitrogen (N) content may preferably be 0.0015% to 0.015%.

Nickel (Ni): 0.01% to 2.0%

Nickel (Ni) is almost the only element able to improve both strength and toughness of a base metal, and in order to achieve such an effect, in the present disclosure, 0.01% or more of nickel (Ni) may be added. A nickel (Ni) content may preferably be 0.05% or more and more preferably 0.1% or more. However, nickel (Ni) is an expensive element, and thus, an excessive addition thereof is not desirable in terms of economic efficiency, and in addition, an excessive addition thereof may deteriorate weldability, and thus, in the present disclosure, an upper limit of the nickel (Ni) content may be limited to 2.0%. The nickel (Ni) content may be preferably 1.5% or less and more preferably 1.0% or less.

Copper (Cu): 0.01% to 1.0%

Copper (Cu) is an element contributing to improving strength, while minimizing a decrease in toughness of a base metal. Therefore, in order to achieve such an effect, in the present disclosure, 0.01% or more of copper (Cu) may be added. A copper (Cu) content may be preferably 0.015% or more and more preferably 0.02% or more. However, an excessive addition of copper (Cu) may impair quality of a surface of a final product, and thus, in the present disclosure, an upper limit of the copper (Cu) content may be limited to 1.0%. The copper (Cu) content may preferably be 0.8% or less and more preferably 0.6% or less.

Chrome (Cr): 0.01% to 1.0%

Since chromium (Cr) is an element increasing hardenability to effectively contribute to an increase in strength, and thus, in the present disclosure, 0.01% or more of chromium (Cr) may be added. A chromium (Cr) content may preferably be 0.05% or more and more preferably 0.1% or more. However, an excess of the content of chromium (Cr) may significantly deteriorate weldability, and thus, in the present disclosure, an upper limit of the content of chromium (Cr) may be limited to 1.0%. The chromium (Cr) content may preferably be 0.8% or less and more preferably 0.6% or less.

Molybdenum (Mo): 0.01% to 1.0%

Molybdenum (Mo) is an element significantly improving hardenability with only a small amount of addition. Molybdenum (Mo) may suppress an occurrence of ferrite, thereby significantly improving strength of a steel. Therefore, in order to achieve such an effect, in the present disclosure, 0.01% or more of molybdenum (Mo) may be added. A molybdenum (Mo) content may preferably be 0.03% or more and more preferably 0.05% or more. However, an excess of the content of molybdenum (Mo) may excessively increase hardness of a welding portion, and thus, in the present disclosure, an upper limit of the molybdenum (Mo) content may be limited to 1.0%. The molybdenum (Mo) content may preferably be 0.8% or less and more preferably 0.6% or less.

Titanium (Ti): 0.005% to 0.1%

Titanium (Ti) is an element suppressing growth of grains during reheating to significantly improve low-temperature toughness. Therefore, in order to achieve such an effect, in the present disclosure, 0.005% or more of titanium (Ti) may be added. A titanium (Ti) content may preferably be 0.007% or more and more preferably 0.01% or more. However, an excessive addition of titanium (Ti) may cause problems such as clogging of a nozzle or reduction in low-temperature toughness due to crystallization in the central portion, and thus, in the present disclosure, an upper limit of the titanium (Ti) content may be limited to 0.1%. The titanium (Ti) content may preferably be 0.08% or less and more preferably 0.05% or less.

Niobium (Nb): 0.005% to 0.1%

Niobium (Nb) is one of the elements playing an important role in the manufacturing of TMCP steel and is also an element deposited in the form of carbides or nitrides to significantly contribute to improving strength of a base metal and a welded portion. In addition, niobium (Nb) dissolved during reheating of a slab inhibits recrystallization of austenite and inhibits transformation of ferrite and bainite, thereby refining a structure. In the present disclosure, 0.005% or more of niobium (Nb) may be added. A niobium (Nb) content may preferably be 0.01% or more and more preferably 0.02% or more. However, an excess of the content of niobium (Nb) may form coarse precipitates to cause brittle cracks at the edges of the steel, and thus, an upper limit of the niobium (Nb) content may be limited to 0.1%. The niobium (Nb) content may preferably be 0.09% or less and more preferably 0.07% or less.

Vanadium (V): 0.005% to 0.3%

Vanadium (V) has a low solution temperature compared to other alloy compositions and is precipitated at a welding heat affecting portion to prevent lowering of strength of a welded portion. Thus, in order to achieve such an effect, in the present disclosure, a vanadium (V) content may preferably be 0.01% or more and more preferably 0.02% or more. However, an excessive addition of vanadium (V) may reduce toughness of the steel, and thus, in the present disclosure, an upper limit of the vanadium (V) content may be limited to 0.3%. The vanadium (V) content may preferably be 0.2% or less and more preferably 0.1% or less.

Boron (B): 0.0005% to 0.004%

Boron (B) is an inexpensive additional element but is also a beneficial element that may effectively increase hardenability even with a small amount of addition. In addition, since boron (B) in the present disclosure is an element significantly contributing to formation of bainite even under low-speed cooling conditions during cooling after rough rolling, 0.0005% or more of boron (B) may be added for such an effect. A boron (B) content may preferably be 0.0007% or more and more preferably 0.001% or more. However, an excessive addition of boron (B) may form Fe₂₃(CB)₆ to rather lower hardenability and significantly lower low-temperature toughness, and thus, in the present disclosure, an upper limit of the boron (B) content may be limited to 0.004%.

Calcium (Ca): 0.006% or Less

Calcium (Ca) is an element controlling a shape of a non-metallic inclusion, such as MnS or the like and improves low-temperature toughness, and thus, in the present disclosure, calcium (Ca) may be added for this effect. However, an excessive addition of calcium (Ca) may cause formation of a large amount of CaO—CaS and formation of coarse inclusions due to bonding, which may lower cleanliness of the steel and weldability in the field. Therefore, in the present disclosure, an upper limit of the calcium (Ca) content may be limited to 0.006%.

In the present disclosure, the balance other than the steel composition described above may include Fe and inevitable impurities. The inevitable impurities, which may be unintentionally mixed in a general steel manufacturing process, cannot be completely excluded, which may be easily understood by those skilled in the general steel manufacturing field. In addition, in the present disclosure, an addition of compositions other than the steel compositions mentioned above is not entirely excluded.

The structural steel having excellent brittle fracture resistance according to an aspect of the present disclosure is not particularly limited in thickness and may preferably be a thick structural steel having a thickness of 100 mm or more and more preferably be a thick structural steel having a thickness of 20 mm to 100 mm.

Hereinafter, a microstructure of the present disclosure will be described in more detail.

A structural steel of the present disclosure may be divided into surface layer portions adjacent to surfaces of the steel and a central portion located between surface layer portions microstructurally distinguished from each other in a thickness direction of the steel. The surface layer portion may be divided into an upper surface portion adjacent to an upper portion of the steel and a lower surface layer portion adjacent to a lower portion of the steel, and the upper surface layer portion and the lower surface layer portion may have a thickness of about 3% to 10% of a thickness t of the steel.

The surface layer portion may include tempered bainite as a matrix structure and may include fresh martensite and austenite as a second structure and a residual structure, respectively. A fraction occupied by tempered bainite and fresh martensite in the surface layer portion may be 95 area % or more, and a fraction occupied by the austenite structure in the surface layer portion may be 5 area % or less. A fraction occupied by the austenite structure in the surface layer portion may be 0 area %.

The central portion may include bainitic ferrite as a matrix structure, and a fraction occupied by bainitic ferrite in the central portion may be 95 area % or more. In terms of securing desired strength, a more preferable fraction of bainitic ferrite may be 98 area % or more.

An average grain size of the microstructure of the surface layer portion may be 3 μm or less (excluding 0 μm), and an average grain size of the microstructure of the central portion may be 5 to 20 μm. Here, the average grain size of the microstructure of the surface layer portion may refer to a case in which an average grain size of each of tempered bainite, fresh martensite, and austenite is 3 μm or less (excluding 0 μm), and the average grain size of the microstructure of the central portion may refer to a case in which an average grain size of bainitic ferrite is 5 to 20 μm. More preferably, an average grain size of the microstructure of the central portion may be 10 to 20 μm.

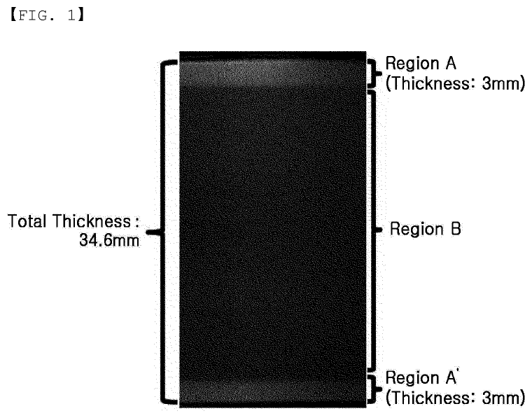

FIG. 1 is a photograph of a cross-section of a steel specimen according to an embodiment of the present disclosure. As shown in FIG. 1, the steel specimen according to an embodiment of the present disclosure is divided into upper and lower surface layer portions A and A′ adjacent to upper and lower surfaces and a central portion B between the upper and lower surface layer portions A and A′, and boundaries between the upper and lower surface layer portions A and A′ and the central portion B are apparent to be visible with naked eyes. That is, it can be seen that the upper and lower surface layer portions A and A′ and the central portion B of the steel according to an embodiment of the present disclosure are apparently distinguished from each other microstructurally.

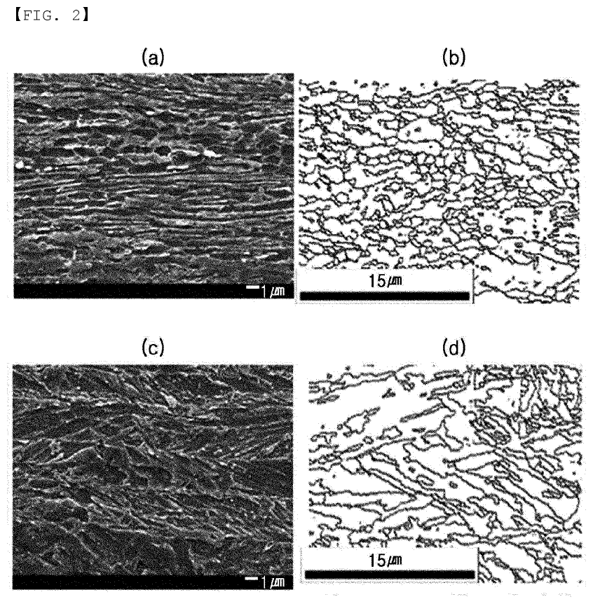

FIG. 2 is a photograph of observing microstructures of the upper surface layer portion A and the central portion B of the specimen of FIG. 1. (a) and (b) of FIG. 2 show an image of the upper surface layer portion A of the specimen observed by a scanning electron microscope (SEM) and an image of high angle grain boundary map of the upper surface layer portion A of the specimen captured using an electron back scattering diffraction (EBSD) method, and (c) and (d) of FIG. 2 show an image of the central portion B of the specimen observed by an SEM and an image of high angle grain boundary map of the central portion B of the specimen captured using the EBSD. As shown in (a) to (d) of FIG. 2, it can be seen that the upper surface layer portion A includes tempered bainite and fresh martensite having an average grain size of about 3 μm or less, while the central portion B includes bainitic ferrite having an average grain size of about 15 μm.

Since the structural steel having excellent brittle fracture resistance according to an aspect of the present disclosure has the surface layer portions and the central portion distinguished from each other microstructurally and the central portion includes bainitic ferrite as a matrix structure, high-strength properties with a tensile strength exceeding 780 MPa, preferably, tensile strength of 800 MPa or more may be effectively secured.

In addition, since the structural steel having excellent brittle fracture resistance according to an aspect of the present disclosure has the surface layer portions and the central portion distinguished from each other microstructurally and the relatively fine-grained surface layer portions include tempered bainite as a matrix structure and fresh martensite as a second structure and secure 45% or more of high angle grain boundary fraction, an NDT temperature of −70° C. or lower may be secured. Therefore, since the steel of the present disclosure effectively inhibits an occurrence and progress of brittle cracks by the fine-grained surface layer portions, brittle fracture resistance may be effectively secured.

Hereinafter, a manufacturing method of the present disclosure will be described in more detail.

Slab Reheating

Since a slab provided in the manufacturing method of the present disclosure has a steel composition corresponding to the steel composition of the steel described above, a description of the steel composition of the slab is replaced with the description of the steel composition of the steel described above.

The slab manufactured with the steel composition described above may be reheated in a temperature range of 1050° C. to 1250° C. In order to sufficiently solidify carbonitrides of Ti and Nb formed during casting, a lower limit of the reheating temperature of the slab may be limited to 1050° C. However, if the reheating temperature is excessively high, austenite may become coarse and an excessive time may be required for a temperature of a surface layer portion of a rough-rolled bar to reach a first cooling start temperature after rough rolling, and thus, an upper limit of the reheating temperature may be limited to 1250° C.

Rough Rolling

Rough rolling may be performed after reheating in order to adjust a shape of the slab and destroy a casting structure such as dendrite. To control the microstructure, it is desirable to perform rough rolling at a temperature higher than a temperature at which recrystallization of austenite stops (Tnr, ° C.), and an upper limit of a temperature for rough rolling is preferably limited to 1150° C. in consideration of the cooling start temperature of the first cooling. Therefore, the temperature for rough rolling of the present disclosure may range from Tnr to 1150° C. In addition, rough rolling of the present disclosure may be carried out under conditions of a cumulative reduction ratio of 20% to 70%.

First Cooling

After rough rolling is finished, first cooling may be performed on the surface layer portion of the rough-rolled bar. A preferred cooling rate of the first cooling may be 5° C./s or higher, and a preferred cooling arrival temperature of the first cooling may be within a temperature range of Ms to Bs° C. if the cooling rate of the first cooling is less than a certain level, a polygonal ferrite or granular bainite structure, rather than a lath bainite structure, may be formed on the surface layer portion, and thus, the cooling rate of first cooling may be limited to 5° C./s or higher. In addition, a cooling method of the first cooling is not particularly limited, but water cooling is more preferable in terms of cooling efficiency. Meanwhile, if the cooling start temperature of the first cooling is too high, a lath bainite structure formed on the surface layer portion by the first cooling may become coarse, and thus, the start temperature of the first cooling is preferably limited to a range of Ae3+100° C. or less.

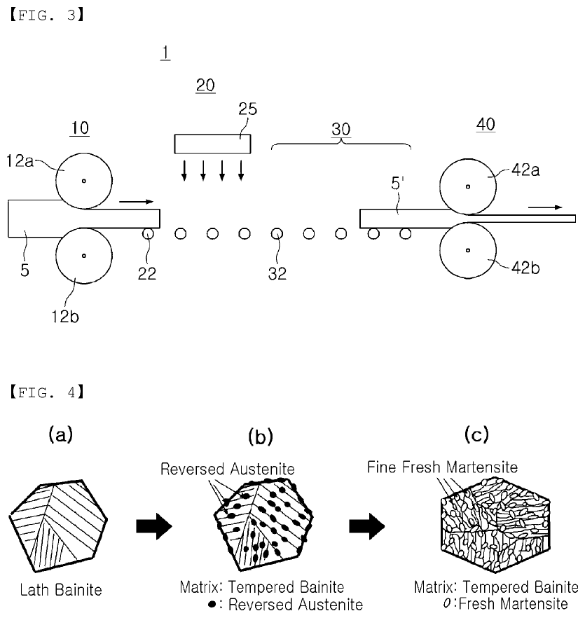

In order to maximize the effect of heat recuperation, the first cooling of the present disclosure is preferably carried out immediately after rough rolling. FIG. 3 is a diagram schematically illustrating an example of a facility 1 for implementing the manufacturing method of the present disclosure. Along a movement path of a slab 5, a rough rolling device 10, a cooling device 20, a heat recuperator 30, and a finish rolling device 40 are sequentially arranged, and the rough rolling device 10 and the finish rolling device 40 include rough rolling rollers 12a and 12b and finish rolling rollers 42a and 42b, respectively, to perform rolling of the slab 5 and a rough rolled bar 5′. The cooling device 20 may include a bar cooler 25 capable of spraying cooling water and an auxiliary roller 22 guiding movement of the rough rolled bar 5′. It is more preferable in terms of maximizing the heat recuperation effect that the bar cooler 25 is disposed directly behind the rough rolling device 10. The heat recuperator 30 is disposed behind the cooling device 20, and the rough rolled bar 5′ may be recuperated, while moving along the auxiliary roller 32. The recuperation-finished rough rolled bar 5′ may be moved to the finish rolling device 40 to be finish-rolled. In the above, a facility for manufacturing a high-strength structural steel having excellent brittle fracture resistance according to an aspect of the present disclosure has been described based on FIG. 3, but such facility 1 is an example of a facility for carrying out the present disclosure and the present disclosure should not necessarily be construed as being manufactured by the facility 1 shown in FIG. 3.

Heat Recuperation Treatment

After performing the first cooling, a heat recuperation treatment may be performed to maintain the surface layer portion side of the rough rolled bar to be reheated by high heat at the central portion side of the rough rolled bar. The heat recuperation treatment may be carried out until a temperature of the surface layer portion of the rough rolled bar reaches a temperature range of (Ac1+40° C.)˜(Ac3-5° C.). By the heat recuperation treatment, lath bainite in the surface layer portion may be transformed into fine tempered bainite, and a portion of the lath bainite in the surface layer portion may be reversely transformed into austenite. A portion of the reversely transformed austenite may be transformed into fresh martensite through subsequent finish rolling and second cooling.

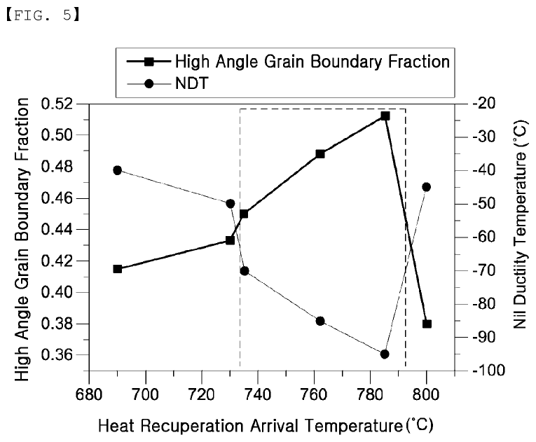

FIG. 4 is a conceptual diagram schematically illustrating a change in a microstructure of a surface layer portion by heat recuperation treatment of the present disclosure.

As shown in (a) of FIG. 4, the microstructure of the surface layer portion immediately after the first cooling may include a lath bainite structure. As shown in (b) of FIG. 4, as the heat recuperation treatment proceeds, the lath bainite of the surface layer portion is transformed into a tempered bainite structure, and a portion of the lath bainite in the surface layer portion may be reversely transformed into austenite. After the heat recuperation treatment, finish rolling and second cooling may be performed and a two-phase mixed structure including tempered bainite and fresh martensite may be formed and austenite structure may partially remain as shown in (c) of FIG. 4.

FIG. 5 is a graph illustrating a experimentally measured relationship among a heat recuperation treatment arrival temperature, a high angle grain boundary fraction of the surface layer portion and an NDT temperature. In the test of FIG. 5, a specimen was manufactured under conditions that satisfy the alloy composition and manufacturing method of the present disclosure and testing was conducted by varying the heat recuperation treatment arrival temperature in a heat recuperation treatment. Here, a fraction of high angle grain boundary having an orientation difference of 15 degrees or more was measured and evaluated using an EBSD method, and an NDT temperature was measured by an NRL drop weight test described above. As shown in FIG. 5, it can be seen that, when an arrival temperature of the surface layer portion is lower than (Ac1+40° C.), high angle grain boundaries of 15° C. or more were not sufficiently formed and the NDT temperature exceeded −70° C. In addition, when the arrival temperature of the surface layer portion exceeded (Ac3-5° C.), the high angle grain boundaries of 15° C. or more were not sufficiently formed and the NDT temperature exceeded −70° C. Therefore, in the present disclosure, the arrival temperature of the surface layer portion during the heat recuperation treatment may be limited to a temperature range of (Ac1+40° C.)˜(Ac3-5° C.)), whereby the surface layer structure may be refined, 45% or more of high angle grain boundary fraction of 15° C. or more may be secured, and the NDT temperature of −70° C. or lower can be effectively secured.

Finish Rolling

Finish rolling is performed to introduce a non-uniform microstructure into the austenite structure of the rough rolled bar. Finish rolling may be performed in a temperature range equal to or higher than a bainite transformation start temperature (Bs) and lower than an austenite recrystallization temperature (Tnr).

Second Cooling

After finishing the finish rolling, second cooling may be performed to form bainitic ferrite in the center of the steel. A preferred cooling rate of the second cooling may be 5° C./s or more, and a preferred cooling arrival temperature of the second cooling may be 500° C. or lower. In addition, if the second cooling arrival temperature is too low, the formation of bainitic ferrite may not increase any more, while time and cost required for cooling may excessively increase, and an equipment load may occur due to distortion of a plate shape or the like. Therefore, in the present disclosure, the second cooling arrival temperature may be limited to 200° C. or higher. A cooling method of the second cooling is also not particularly limited, but water cooling may be preferable in terms of cooling efficiency. If the cooling arrival temperature of the second cooling exceeds a certain range or the cooling rate does not reach a certain level, granular ferrite may be formed in the center of the steel, thereby causing a decrease in strength, and thus, in the present disclosure, the cooling arrival temperature of the second cooling may be limited to 500° C. or lower and the cooling rate may be limited to 5° C./s or more.

### DESCRIPTION OF REFERENCE NUMERALS

1: STEEL MANUFACTURING FACILITY 10: ROUGH ROLLING DEVICE 12A,B: ROUGH ROLLING ROLLER

20: COOLING DEVICE 22: AUXILIARY ROLLER

25: BAR COOLER

30: HEAT RECUPERATOR 32: AUXILIARY ROLLER

40: FINISH ROLLING DEVICE

42A,B: FINISH ROLLING ROLLER 100: COLD ROLLED BENDING FIXTURE 110: STEEL

### Mode for Invention

Hereinafter, the present disclosure will be described in more detail through specific examples.

### EXAMPLE

Slabs having the steel compositions of Table 1 were prepared, and transformation temperatures were calculated based on the steel compositions of Table 1 and shown in Table 2. In Table 1 below, the content of boron (B), nitrogen (N) and calcium (Ca) is based on ppm.

TABLE 1

| | Alloy composition (wt %) | | | | | | | | | | | | | | | |
|---|---|---|---|---|---|---|---|---|---|---|---|---|---|---|---|---|
| Steel | | | | | | | | | | | | | | | | |
| Grade | C | Si | Mn | P | S | Al | Ni | Cu | Cr | Mo | Ti | Nb | V | B* | N* | Ca* |
| A | 0.05 | 0.15 | 2.24 | 0.013 | 0.002 | 0.015 | 0.4 | 0.26 | 0.35 | 0.16 | 0.016 | 0.04 | 0.04 | 12 | 40 | 12 |
| B | 0.044 | 0.35 | 1.95 | 0.013 | 0.005 | 0.032 | 0.8 | 0 | 0 | 0.35 | 0.013 | 0.04 | 0 | 15 | 54 | 27 |
| C | 0.047 | 0.3 | 2.15 | 0.012 | 0.002 | 0.023 | 0.33 | 0.17 | 0 | 0 | 0.015 | 0.04 | 0 | 40 | 45 | 18 |
| D | 0.09 | 0.45 | 2.1 | 0.013 | 0.003 | 0.035 | 0.43 | 0 | 0.46 | 0 | 0.019 | 0.04 | 0 | 8 | 41 | 28 |
| E | 0.07 | 0.25 | 2.3 | 0.013 | 0.002 | 0.03 | 0 | 0.27 | 0 | 0 | 0.018 | 0.03 | 0 | 16 | 43 | 15 |
| F | 0.015 | 0.21 | 1.43 | 0.014 | 0.002 | 0.035 | 0 | 0 | 0 | 0 | 0.012 | 0.03 | 0 | 21 | 38 | 17 |
| G | 0.19 | 0.32 | 0.75 | 0.013 | 0.001 | 0.04 | 0 | 0.02 | 0 | 0 | 0.016 | 0.03 | 0 | 25 | 35 | 10 |
| H | 0.08 | 0.42 | 1.1 | 0.011 | 0.003 | 0.024 | 0 | 0 | 0.48 | 0 | 0.012 | 0.04 | 0 | 13 | 32 | 5 |
| I | 0.079 | 0.25 | 1.3 | 0.016 | 0.004 | 0.03 | 0 | 0 | 0 | 0.07 | 0.01 | 0.04 | 0 | 1 | 50 | 13 |

TABLE 2

| Steel | Temperature (° C.) | | | | |
|---|---|---|---|---|---|
| grade | Bs | Tnr | Ms | Ac3 | Ac1 |
| A | 562 | 984 | 437 | 795 | 703 |
| B | 584 | 935 | 444 | 796 | 699 |
| C | 612 | 952 | 448 | 790 | 703 |
| D | 569 | 927 | 424 | 774 | 714 |
| E | 604 | 948 | 439 | 776 | 706 |
| F | 697 | 933 | 489 | 823 | 714 |
| G | 711 | 972 | 436 | 782 | 724 |
| H | 676 | 923 | 466 | 822 | 732 |
| I | 686 | 988 | 466 | 800 | 716 |

The slabs having the compositions of Table 1 were subjected to rough rolling, first cooling and a heat recuperation treatment under the conditions of Table 3 below, and finish rolling and second cooling were performed under the conditions of Table 4. The evaluation results for the steels manufactured under the conditions of Tables 3 and 4 are shown in Table 5 below.

For each steel material, an average grain size of the surface layer, a high angle grain boundary fraction of the surface layer, mechanical properties, and an NDT temperature were measured. Among these, a region of 500 m*500 m was measured as a 0.5 m step size by an EBSD method, a grain boundary map having a crystal orientation difference of 15 degrees or more with adjacent grains was created based on the measured step size, based on which an average grain size and high angle grain boundary fraction were evaluated. For yield strength (YS) and tensile strength (TS), three test pieces were subjected to a tensile strength test in a plate width direction and an average thereof was obtained and evaluated. The NDT temperature was evaluated by the NRL drop weight test specified in ASTM E208, a P-2 type (thickness: 19 mm, width: 51 mmm, length: 127 mm) specimen was prepared, the specimen was fully immersed in a stirring thermostat to maintain a uniform temperature, and thereafter, the NRL drop weight test was performed.

TABLE 3

| | | | | | | | Heat | |
|---|---|---|---|---|---|---|---|---|
| | | | | | | | recuper- | |
| | | | | | | | ation | |
| | | | | | | | treatment | |
| | | Reheating and rough | | | | | Heat | |
| | | rolling | | | | | recuper- | |
| | | Thickness | Reduc- | | | First | ation | |
| | | of | tion | Reheat | Rough | cooling | treatment | |
| | | slab | ratio | extrac- | rolling | Cooling | arrival | |
| | | before | of | tion | end | end | surface | |
| | | rough | rough | temper- | temper- | temper- | temper- | |
| Steel | Classifi- | rolling | rolling | ature | ature | ature | ature | |
| grade | cation | (mm) | (%) | (° C.) | (° C.) | (° C.) | (° C.) | Remark |
| A | A-1 | 244 | 40 | 1070 | 1000 | 559 | 773 | Recommended |
| | | | | | | | | condition |
| | A-2 | 244 | 39 | 1085 | 990 | 549 | 763 | Recommended |
| | | | | | | | | condition |
| | A-3 | 220 | 32 | 1110 | 1040 | 551 | 779 | Recommended |
| | | | | | | | | condition |
| | A-4 | 244 | 23 | 1110 | 1070 | 629 | 843 | Higher |
| | | | | | | | | than |
| | | | | | | | | heat |
| | | | | | | | | recuperation |
| | | | | | | | | treatment |
| | | | | | | | | temperature |
| | A-5 | 220 | 36 | 1110 | 950 | 461 | 689 | Lower |
| | | | | | | | | than |
| | | | | | | | | heat |
| | | | | | | | | recuperation |
| | | | | | | | | treatment |
| | | | | | | | | temperature |
| | A-6 | 220 | 26 | 1050 | 1020 | 531 | 759 | Recommended |
| | | | | | | | | condition |
| B | B-1 | 244 | 33 | 1080 | 1000 | 559 | 773 | Recommended |
| | | | | | | | | condition |
| | B-2 | 244 | 33 | 1080 | 1000 | 559 | 773 | Recommended |
| | | | | | | | | condition |
| | B-3 | 220 | 27 | 1100 | 1040 | 551 | 779 | Recommended |
| | | | | | | | | condition |
| | B-4 | 244 | 22 | 1100 | 1080 | 639 | 853 | Higher |
| | | | | | | | | than |
| | | | | | | | | heat |
| | | | | | | | | recuperation |
| | | | | | | | | treatment |
| | | | | | | | | temperature |
| | B-5 | 220 | 30 | 1080 | 950 | 461 | 689 | Lower |
| | | | | | | | | than |
| | | | | | | | | heat |
| | | | | | | | | recuperation |
| | | | | | | | | treatment |
| | | | | | | | | temperature |
| C | C-1 | 244 | 25 | 1090 | 1000 | 559 | 773 | Recommended |
| | | | | | | | | condition |
| | C-2 | 244 | 33 | 1070 | 990 | 549 | 763 | Recommended |
| | | | | | | | | condition |
| | C-3 | 244 | 23 | 1110 | 1085 | 644 | 858 | Higher |
| | | | | | | | | than |
| | | | | | | | | heat |
| | | | | | | | | recuperation |
| | | | | | | | | treatment |
| | | | | | | | | temperature |
| | C-4 | 220 | 41 | 1070 | 980 | 491 | 719 | Lower |
| | | | | | | | | than |
| | | | | | | | | heat |
| | | | | | | | | recuperation |
| | | | | | | | | treatment |
| | | | | | | | | temperature |
| | C-5 | 220 | 23 | 1070 | 1020 | 531 | 759 | Recommended |
| | | | | | | | | condition |
| D | D-1 | 244 | 33 | 1065 | 985 | 544 | 758 | Recommended |
| | | | | | | | | condition |
| | D-2 | 244 | 33 | 1070 | 990 | 549 | 763 | Recommended |
| | | | | | | | | condition |
| | D-3 | 244 | 25 | 1100 | 1040 | 599 | 813 | Higher |
| | | | | | | | | than |
| | | | | | | | | heat |
| | | | | | | | | recuperation |
| | | | | | | | | treatment |
| | | | | | | | | temperature |
| | D-4 | 220 | 23 | 1020 | 970 | 481 | 709 | Lower |
| | | | | | | | | than |
| | | | | | | | | heat |
| | | | | | | | | recuperation |
| | | | | | | | | treatment |
| | | | | | | | | temperature |
| E | E-1 | 244 | 33 | 1060 | 980 | 539 | 753 | Recommended |
| | | | | | | | | condition |
| | E-2 | 244 | 35 | 1075 | 990 | 549 | 763 | Recommended |
| | | | | | | | | condition |
| | E-3 | 244 | 49 | 1110 | 990 | 549 | 763 | Recommended |
| | | | | | | | | condition |
| F | F-1 | 244 | 37 | 1090 | 1000 | 559 | 773 | Recommended |
| | | | | | | | | condition |
| G | G-1 | 244 | 37 | 1090 | 1000 | 559 | 773 | Recommended |
| | | | | | | | | condition |
| H | H-1 | 244 | 31 | 1080 | 1005 | 564 | 778 | Recommended |
| | | | | | | | | condition |
| I | I-1 | 244 | 37 | 1080 | 990 | 549 | 763 | Recommended |
| | | | | | | | | condition |

TABLE 4

| | | Finish rolling | | Second cooling | | |
|---|---|---|---|---|---|---|
| | | Rolling | Rolling | | Cooling | |
| | | start | end | | end | |
| | | temper- | temper- | Cooling | temper- | |
| Steel | Classifi- | ature | ature | rate | ature | |
| grade | cation | (° C.) | (° C.) | (° C./sec) | (° C.) | Remark |
| A | A-1 | 900 | 860 | 15.0 | 250 | Recommended |
| | | | | | | condition |
| | A-2 | 900 | 860 | 10.0 | 350 | Recommended |
| | | | | | | condition |
| | A-3 | 930 | 890 | 7.0 | 350 | Recommended |
| | | | | | | condition |
| | A-4 | 970 | 930 | 8.0 | 390 | Recommended |
| | | | | | | condition |
| | A-5 | 850 | 810 | 7.0 | 390 | Recommended |
| | | | | | | condition |
| | A-6 | 900 | 860 | 8.0 | 600 | Cooling end |
| | | | | | | temperature |
| | | | | | | high |
| | | | | | | temperature |
| B | B-1 | 900 | 860 | 15.0 | 260 | Recommended |
| | | | | | | condition |
| | B-2 | 900 | 860 | 20.0 | 350 | Recommended |
| | | | | | | condition |
| | B-3 | 920 | 880 | 15.0 | 280 | Recommended |
| | | | | | | condition |
| | B-4 | 930 | 890 | 20.0 | 300 | Recommended |
| | | | | | | condition |
| | B-5 | 880 | 840 | 8.0 | 400 | Recommended |
| | | | | | | condition |
| C | C-1 | 900 | 860 | 10.0 | 280 | Recommended |
| | | | | | | condition |
| | C-2 | 880 | 840 | 25.0 | 330 | Recommended |
| | | | | | | condition |
| | C-3 | 950 | 910 | 10.0 | 400 | Recommended |
| | | | | | | condition |
| | C-4 | 870 | 830 | 8.0 | 400 | Recommended |
| | | | | | | condition |
| | C-5 | 910 | 870 | 10.0 | 550 | Cooling end |
| | | | | | | temperature |
| | | | | | | high |
| | | | | | | temperature |
| D | D-1 | 900 | 860 | 15.0 | 270 | Recommended |
| | | | | | | condition |
| | D-2 | 890 | 850 | 15.0 | 350 | Recommended |
| | | | | | | condition |
| | D-3 | 850 | 810 | 10.0 | 400 | Recommended |
| | | | | | | condition |
| | D-4 | 860 | 820 | 10.0 | 250 | Recommended |
| | | | | | | condition |
| E | E-1 | 910 | 870 | 15.0 | 250 | Recommended |
| | | | | | | condition |
| | E-2 | 890 | 850 | 20.0 | 400 | Recommended |
| | | | | | | condition |
| | E-3 | 890 | 850 | 3.0 | 490 | Lower cooling |
| | | | | | | rate |
| F | F-1 | 900 | 860 | 10.0 | 370 | Recommended |
| | | | | | | condition |
| G | G-1 | 890 | 850 | 10.0 | 370 | Recommended |
| | | | | | | condition |
| H | H-1 | 910 | 870 | 10.0 | 370 | Recommended |
| | | | | | | condition |
| I | I-1 | 890 | 850 | 10.0 | 370 | Recommended |
| | | | | | | condition |

TABLE 5

| | | | surface | | Physical properties | | | |
|---|---|---|---|---|---|---|---|---|
| | | | Thick- | | | | High | |
| | | Pro- | ness of | | | | angle | |
| | | duct | surface | Average | | | grain | |
| | Clas- | thick- | layer | grain | | | boundary | |
| Steel | sifi- | ness | portion | size | YS | TS | fraction | NDT |
| grade | cation | (mm) | (mm) | (μm) | (MPa) | (MPa) | (%) | (° C.) |
| A | A-1 | 75 | 3 | 1.9 | 725 | 865 | 0.48 | −75 |
| | A-2 | 25 | 1 | 1.8 | 764 | 899 | 0.47 | −75 |
| | A-3 | 50 | 2 | 1.8 | 731 | 875 | 0.49 | −75 |
| | A-4 | 60 | 0 | 10.0 | 739 | 876 | 0.37 | −30 |
| | A-5 | 30 | 0 | 6.5 | 750 | 890 | 0.42 | −50 |
| | A-6 | 65 | 2 | 2.5 | 672 | 780 | 0.47 | −70 |
| B | B-1 | 80 | 3 | 2.2 | 710 | 825 | 0.48 | −80 |
| | B-2 | 35 | 1 | 2.6 | 718 | 869 | 0.48 | −75 |
| | B-3 | 50 | 2 | 2.1 | 715 | 868 | 0.49 | −80 |
| | B-4 | 30 | 0 | 9.9 | 712 | 851 | 0.37 | −30 |
| | B-5 | 70 | 0 | 5.5 | 740 | 869 | 0.42 | −50 |
| C | C-1 | 85 | 3 | 2.0 | 712 | 881 | 0.49 | −90 |
| | C-2 | 25 | 1 | 2.0 | 738 | 892 | 0.47 | −95 |
| | C-3 | 65 | 0 | 11.2 | 716 | 861 | 0.36 | −30 |
| | C-4 | 25 | 0 | 4.5 | 730 | 891 | 0.43 | −50 |
| | C-5 | 40 | 2 | 1.8 | 635 | 792 | 0.47 | −95 |
| D | D-1 | 55 | 2 | 2.1 | 712 | 860 | 0.48 | −70 |
| | D-2 | 25 | 1 | 2.5 | 726 | 865 | 0.49 | −70 |
| | D-3 | 50 | 0 | 10.3 | 706 | 858 | 0.37 | −35 |
| | D-4 | 35 | 0 | 5.4 | 723 | 863 | 0.42 | −50 |
| E | E-1 | 65 | 2 | 2.1 | 718 | 854 | 0.47 | −75 |
| | E-2 | 20 | 1 | 2.0 | 715 | 834 | 0.49 | −95 |
| | E-3 | 50 | 2 | 2.0 | 665 | 795 | 0.49 | −75 |
| F | F-1 | 70 | 2 | 2.2 | 347 | 463 | 0.46 | −80 |
| G | G-1 | 55 | 1 | 2.5 | 342 | 546 | 0.49 | −85 |
| H | H-1 | 50 | 1 | 2.4 | 495 | 608 | 0.46 | −80 |
| I | I-1 | 65 | 2 | 2.6 | 435 | 561 | 0.46 | −90 |

Steel grades A, B, C, D and E are steels satisfying the alloy composition of the present disclosure. Among them, it can be seen that, in A-1, A-2, A-3, B-1, B-2, B-3, C-1, C-2, D-1, D-2, E-1, and E-2 satisfying process conditions of the present disclosure, a high angle grain boundary fraction of a surface layer portion is 45% or more and an average grain size of the surface layer portion has a certain level or higher, and an NDT temperature is −70° C. or lower.

In the case of A-4, B-4, C-3, and D-3 in which the alloy composition of the present disclosure is satisfied but the heat recuperation treatment temperature exceeds the range of the present disclosure, it can be seen that the high angle grain boundary fraction of the surface layer portion is 45% Is less and the average grain size of the surface layer portion exceeds 3 μm, and the NDT temperature exceeds −70° C. This is because the surface layer portion of the steel was heated to a temperature higher than a two-phase region heat treatment temperature section, a structure of the surface layer portion was entirely reversely transformed to austenite, and as a result, a final structure of the surface layer portion was formed as lath bainite.

In the case of A-5, B-5, C-4, and D-4 in which the alloy composition of the present disclosure is satisfied but a heat recuperation treatment temperature is less than the range of the present disclosure, it can be seen that the high angle grain boundary fraction of the surface layer portion is 45% or less, the average grain size of the surface layer portion exceeds 3 μm, and the NDT temperature exceeds −70° C. This is because the surface layer portion of the steel was excessively cooled during the first cooling, so reversed austenite was not sufficiently formed in the surface layer portion.

In the case of A-6 and C-5 in which the alloy composition of the present disclosure is satisfied but a cooling end temperature of the second cooling exceeds the range of the present disclosure or in the case of E-3 in which the cooling rate of the second cooling does not fall within the range of the present disclosure, it can be seen that tensile strength is relatively low. In addition, as a result of observing a microstructure of a central portion of each specimen, in the case of A-1, A-2, A-3, B-1, B-2, B-3, C-1, C-2, D-1, D-2, E-1, and E-2 satisfying the alloy composition and the process conditions of the present disclosure, it can be seen that bainitic ferrite was formed in the central portion, whereas in the case of A-6, C-5. and E-3, it can be seen that granular ferrite was formed as a matrix structure. That is, it can be seen that, in order to secure the intended high strength characteristics of the present disclosure, it is effective to form the matrix structure of the central portion as bainitic ferrite.

In the case of F-1. G-1, H-1, and I-1 not satisfying the alloy composition of the present disclosure, it can be seen that the tensile strength is relatively low even though the process conditions of the present disclosure are satisfied, and the high strength characteristics intended in the present disclosure are not secured.

Therefore, in the case of the examples satisfying the alloy composition and process conditions of the present disclosure, it can be seen that high strength characteristics and brittle fracture resistance can be effectively secured by securing the high strength characteristics and the NDT temperature of −70° C. or lower.

While example embodiments have been shown and described above, it will be apparent to those skilled in the art that modifications and variations could be made without departing from the scope of the present disclosure as defined by the appended claims.

1. A structural steel having excellent brittle fracture resistance, the structural steel comprising,
by wt %, 0.02% to 0.12% of carbon (C), 0.01% to 0.8% of silicon (Si), 1.5% to 2.5% of manganese (Mn), 0.005% to 0.5% of aluminum (Al), 0.02% or less of phosphorus (P), 0.01% or less of sulfur (S), 0.0015% to 0.015% of nitrogen (N), and the balance of Fe and other inevitable impurities,
wherein an outer surface layer portion and an inner central portion are microstructurally distinguished from each other in a thickness direction, the surface layer portion comprises a tempered bainite as a matrix structure, the central portion comprises bainitic ferrite as a matrix structure, and a nil ductility transition (NDT) temperature based on naval research lab. (NRL) drop weight test is −70° C. or lower.

2. The structural steel of claim 1, wherein the surface layer portion comprises an upper surface layer portion in an upper portion of the steel and a lower surface layer portion in a lower portion of the steel, and the upper surface layer portion and the lower surface layer portion each have a thickness of 3% to 10% of a thickness of the steel.

3. The structural steel of claim 1, wherein the surface layer portion further comprises fresh martensite as a second structure, and the surface layer portion comprises the tempered bainite and the fresh martensite in a fraction of 95 area % or more.

4. The structural steel of claim 3, wherein the surface layer portion further comprises austenite as a residual structure, and the surface layer portion comprises the austenite in a fraction of 5 area % or less.

5. The structural steel of claim 1, wherein the central portion comprises the bainitic ferrite in a fraction of 95 area % or more.

6. The structural steel of claim 1, wherein an average grain size of the surface layer portion is 3 μm or less (excluding 0 μm).

7. The structural steel of claim 1, wherein an average grain size of the central portion is 5 μm to 20 μm.

8. The structural steel of claim 1, further comprises one or more selected from the group consisting of, by weight %, 0.01% to 2.0% of nickel (Ni), 0.01% to 1.0% of copper (Cu), 0.01% to 1.0% of chromium (Cr), 0.01% to 1.0% of molybdenum (Mo), 0.005% to 0.1% of titanium (Ti), 0.005% to 0.1% of niobium (Nb), 0.005% to 0.3% of vanadium (V), 0.0005% to 0.004% of boron (B), and 0.006% or less of calcium (Ca).

9. The structural steel of claim 1, wherein a high angle grain boundary fraction of the surface layer portion is 45% or more.

10. A method for manufacturing a structural steel having excellent brittle fracture resistance, the method comprising:
re-heating a slab comprising, by wt %, 0.02% to 0.12% of carbon (C), 0.01% to 0.8% of silicon (Si), 1.5% to 2.5% of manganese (Mn), 0.005% to 0.5% of aluminum (Al), 0.02% or less of phosphorus (P), 0.01% or less of sulfur (S), 0.0015% to 0.015% of nitrogen (N), and the balance of Fe and other inevitable impurities in a temperature range of 1050° C. to 1250° C.;
rough-rolling the slab in a temperature range of Tnr to 1150° C. to provide a rough-rolled bar;
first cooling the rough-rolled bar at a cooling rate of 5° C./s or higher to a temperature range of Ms to Bs° C.;
maintaining the first cooled rough-rolled bar such that a surface layer portion thereof is reheated to a temperature range of (Ac1+40° C.)˜(Ac3-5° C.) by heat recuperation;
finish rolling the recuperated rough-rolled bar; and
secondary cooling the finish rolled steel to a temperature range of 200° C. to 500° C. at a cooling rate of 5° C./s or higher.

11. The method of claim 10, wherein the slab further comprises one or two or more selected from the group consisting of, by wt %, 0.01% to 2.0% of nickel (Ni), 0.01% to 1.0% of copper (Cu), 0.01% to 1.0% of chromium (Cr), 0.01% to 1.0% of molybdenum (Mo), 0.005% to 0.1% of titanium (Ti), 0.005% to 0.1% of niobium (Nb), 0.005% to 0.3% of vanadium (V), 0.0005% to 0.004% of boron (B), and 0.006% or less of calcium (Ca).

12. The method of claim 10, wherein the rough-rolled bar is first cooled by water cooling immediately after the rough rolling.

13. The method of claim 10, wherein the first cooling is initiated at a temperature of Ae3+100° C. or lower based on a temperature of a surface layer portion of the rough-rolled bar.

14. The method of claim 10, wherein the rough-rolled bar is finish-rolled in a temperature range of Bs to Tnr° C.
